(19) United States
(12) Patent Application Publication
(10) Pub. No.: US 2012/0178270 A1
(43) Pub. Date: Jul. 12, 2012

(54) Connector For Providing A Releasable Electronic Connection And A Peripheral Module Including The Same

(75) Inventors: Michael McElroy, Gilbert, AZ (US); Valent Horvatich, Scottsdale, AZ (US); Daniel P. Furth, Mesa, AZ (US); Andrew R. Slater, Phoenix, AZ (US)

(73) Assignee: BAE SYSTEMS AEROSPACE & DEFENSE GROUP INC., PHOENIX, AZ (US)

(21) Appl. No.: 12/392,948

(22) Filed: Feb. 25, 2009

(51) Int. Cl. H01R 11/30; H01R 24/00

(52) U.S. Cl. 439/39; 439/660

(57) ABSTRACT

A connector, or a peripheral module including a connector, is configured to form at least a portion of an operative link between a wearable combat processing platform and the peripheral module. The connector may be adapted to facilitate deployment with a soldier or combatant in contexts including battlefield contexts. The wearable combat processing platform may include one or more processors and a power distribution unit. The peripheral module may include one or more peripherals configured to communicate data and to receive power over the operative link with the wearable combat processing platform.

### FIELD OF THE INVENTION

The invention relates to connectors that provide a releasable connection between a wearable combat processing platform and a peripheral module for implementation in a battlefield context.

### BACKGROUND OF THE INVENTION

Releasable connectors for enabling transmission of data and/or power between processing platforms and peripheral devices are known. Generally, the connection provided by these connectors are made more secure by mechanically interlocking the connectors. As such, conventional connectors generally include male and/or female conductive mating elements that enhance this mechanical interconnection.

### SUMMARY

One aspect of the invention relates to a connector, or a peripheral module including a connector, that is configured to form at least a portion of an operative link between a wearable combat processing platform and the peripheral module. The connector may be adapted to facilitate deployment with a soldier or combatant in contexts including battlefield contexts. The wearable combat processing platform may include one or more processors and a power distribution unit. The peripheral module may include one or more peripherals configured to communicate data and to receive power over the operative link with the wearable combat processing platform.

The connector may include a housing that carries a connection interface on a first side. The connection interface may include a plurality of conductive mating elements. The conductive mating elements may be configured to interface with conductive mating elements carried by a connector associated with the wearable combat processing platform. The conductive mating elements may include three sets of conductive mating elements. The first set of conductive mating elements may be configured to enable Universal Serial Bus communication between the wearable combat processing platform and the peripheral module. The second set of one or more conductive mating elements may be configured to enable the provision of DC power to the peripheral module through the connector. The third set of one or more conductive mating elements may be configured to enable video information to be transmitted from the wearable combat processing platform to the peripheral module.

The connector may include one or more magnets disposed at or near the first side of the housing at the periphery of the conductive mating elements, and one or more pieces of magnetic, unmagnetized material disposed at or near the first side of the housing at the periphery of the conductive mating elements. The one or more magnets may be configured to generate a magnetic force between the connector and a connector associated with the wearable combat processing platform. For example, the connector associated with the wearable combat processing platform may carry one or more substances (e.g., unmagnetized magnetic material) that is attracted to the one or more magnets included in the one or more magnets disposed in the connector associated with the peripheral module. The one or more pieces of magnetic, unmagnetized material similarly be configured to contribute to an attractive magnetic force between the connectors of the wearable combat processing module and the peripheral module. For example, the connector associated with the wearable combat processing module may carry one or more magnets that attract the one or more pieces of magnetic material carried by the connector associated with the peripheral module.

The connector may include a cable that extends from the housing to the peripheral module. The cable may be configured to carry signals and/or power from the connector to the peripheral module (and/or vice versa).

The connection interface may be formed on the connector having a substantially planar surface. The conductive mating elements of the connector may be formed to be substantially flush with the planar surface. This may enhance the durability of the connector and/or the ease with which the conductive mating elements can be cleaned and/or kept clear of debris.

The connector may include one or more ramp protrusions that extend from the first side of the housing. The ramp protrusions may be formed such that a given one of the ramp protrusions protrudes by a gradually increasing amount from a lower side of the ramp protrusion to a higher side of the ramp protrusion. The ramp protrusions are configured to interface with the connector associated with the wearable combat processing platform mechanically. The sloping increase of height with which the ramp protrusion is formed such that if the connectors are interfaced and a force is applied to the housing of the connector that moves the connector relative to the connector associated with the wearable combat processing platform in a direction generally parallel with the first side of the housing, the one or more ramp protrusions force the connector and the platform connector apart. The connector associated with the wearable combat processing platform may include intrusions having floors with a corresponding sloped shape.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to enhance battlefield capabilities of a soldier, in accordance with one or more implementations of the invention.

FIG. 2 illustrates a releasable connection, according to one or more implementations of the invention.

FIG. 3 illustrates an exploded view of a module connector in accordance with one or more implementations of the invention.

FIG. 4 illustrates an exploded view of a platform connector, in accordance with one or more implementations of the invention.

FIG. 5 illustrates a releasable connection, according to one or more implementations of the invention.

FIG. 6 illustrates a base of a connection interface, according to one or more implementations of the invention.

FIG. 7 illustrates a base of a connection interface, according to one or more implementations of the invention.

FIG. 8 illustrates a base of a connection interface, according to one or more implementations of the invention.

FIG. 9 illustrates a base of a connection interface, according to one or more implementations of the invention.

FIG. 10 illustrates a base of a connection interface, according to one or more implementations of the invention.

FIG. 11 illustrates a base of a connection interface, according to one or more implementations of the invention.

FIG. 12 illustrates a base of a connection interface, according to one or more implementations of the invention.

FIG. 13 illustrates a base of a connection interface, according to one or more implementations of the invention.

FIG. 14 illustrates a base of a connection interface, according to one or more implementations of the invention.

FIG. 15 illustrates a base of a connection interface, according to one or more implementations of the invention.

FIG. 16 illustrates a base of a connection interface, according to one or more implementations of the invention.

FIG. 17 illustrates a base of a connection interface, according to one or more implementations of the invention.

### DETAILED DESCRIPTION

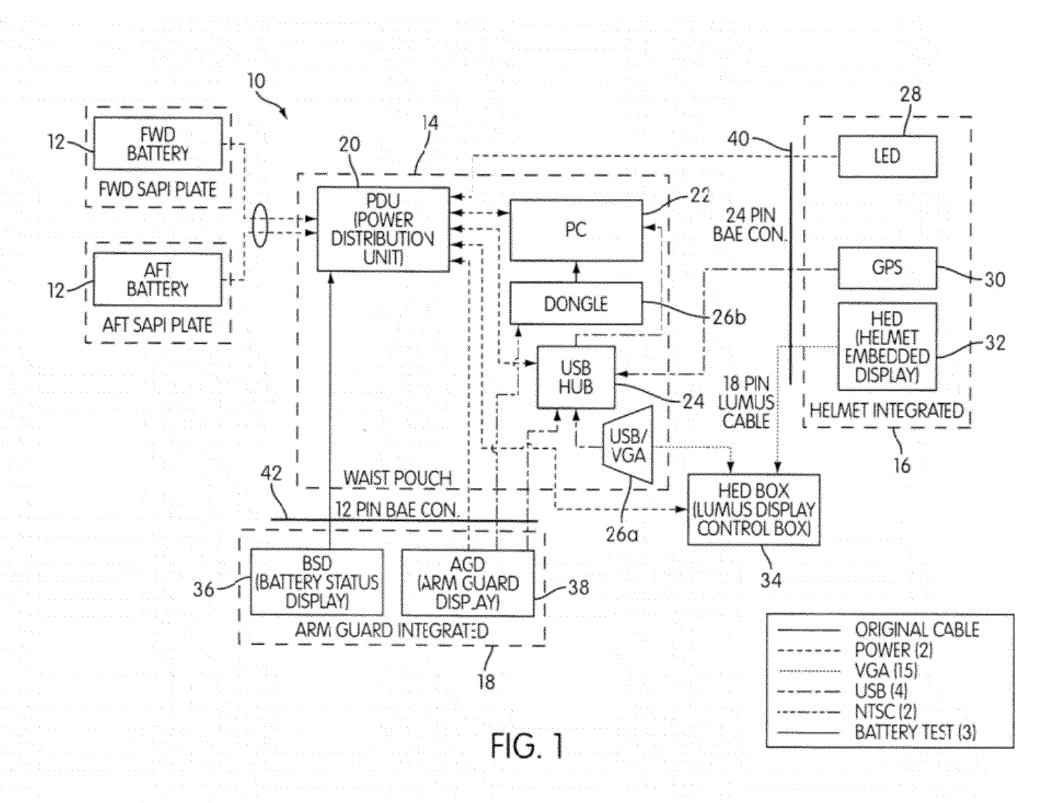

FIG. 1 illustrates a system 10 configured to enhance battlefield capabilities of a soldier. In particular, system 10 provides the soldier with power, communications, sensors configured to detect environmental and/or personal health parameters, strategic information, information processing capabilities, and/or other functionality that enhances the capabilities of the soldier. System 10 is conveniently portable (e.g., wearable, lightweight, etc.), and durable to facilitate battlefield usage. In one embodiment, system 10 includes one or more energy storage devices 12, a wearable combat processing platform 14, a first peripheral module 16, a second peripheral module 18, and/or other components.

The one or more energy storage devices 12 may include one or more devices that store electrical energy for delivery to the other components of system 10. For example, energy storage devices 12 may include a battery, a capacitor, and/or other components capable of storing electrical energy. In some implementations, one or more of energy storage devices 12 may be wearable to facilitate usage by the soldier. For instance, energy storage devices 12 may include the energy storage device disclosed in U.S. patent application Ser. No. 12/246,281, entitled “Body Armor Plate Having Integrated Electronics Modules,” and filed Oct. 6, 2008, which is hereby incorporated into this disclosure in its entirety.

The wearable combat processing platform 14 may be configured to provide the primary processing capabilities within system 10, and may provide a central hub through which information passes between first peripheral module 16, second peripheral module 18, and/or outside entities (e.g., a command center, other soldiers, etc.). In some implementations, wearable combat processing platform 14 may include a power distribution unit 20, a processor 22, a Universal Serial Bus (“USB”) hub 24, one or more video signal generators 26 (illustrated in FIG. 1 as video signal generator 26a and video signal generator 26b), and/or other components. According to various implementations, wearable combat processing platform 14 may be wearable by the soldier to facilitate hands free carrying and/or use of wearable combat processing platform 14 by the soldier during battlefield activities. For example, wearable combat processing platform 14 may be provided in an unobtrusive waist pouch worn by the soldier.

The power distribution unit 20 may be configured to control the distribution of power from energy storage devices 12 to the other components of system 10. For example, one or more of processor 22, USB hub 24, first peripheral module 16, second peripheral module 18, and/or other components of system 10 may be receive power from energy storage devices 12 via power distribution unit 20. The power distribution unit 20 may be configured to condition power appropriately for the various components drawing power from energy storage devices 12, monitor the power levels of energy storage devices 12, achieve power management within system 10, and/or otherwise manage the distribution of power from energy storage devices 12.

The processor 22 may be configured to provide information processing capabilities in system 10. As such, processor 22 may include one or more of a digital processor, an analog processor, a digital circuit designed to process information, an analog circuit designed to process information, a state machine, and/or other mechanisms for electronically processing information. Although processor 22 is shown in FIG. 1 as a single entity, this is for illustrative purposes only. In some implementations, processor 22 may include a plurality of processing units. These processing units may be physically located within the same device in wearable combat processing platform 14, or processor 22 may represent processing functionality of a plurality of devices operating in coordination.

The USB hub 24 may provide interfaces for a plurality of peripheral devices to be operatively linked with wearable combat processing platform 14 via a USB interface. As used herein, a USB interface does not refer to the particular port and connector configurations implemented in standard commercial USB devices and cables. Instead, USB interface, as used herein, may refer to any interface configured to receive and transmit data via USB signaling standards (e.g., a Hi reference signal, a Lo reference signal, a Hi data signal, and a Lo data signal on separate signal lines). Although USB hub 24 is illustrated in FIG. 1 as being a separate device from the other components of wearable combat processing platform 14, this is not intended to be limiting. In some implementations, USB hub 24 may be provided integrally with one or more of the other components shown in FIG. 1 (e.g., processor 22).

The video signal generators 26 may be configured to generate signals that communicate video information to peripheral devices external to wearable combat processing platform 14 (e.g., first peripheral module 16, second peripheral module 18, etc.). Video information may refer to information that enables a dynamic visual display to be generated. The dynamic visual display may include a video, a control/command display, sensor readings, communications information, a series of still images, and/or other dynamic visual displays. In some implementations, video signal generator 26a may generate Video Graphics Array (“VGA”) signals. In some implementations, video signal generator 26b may generate National Television System Committee (“NTSC”) signals.

The first peripheral module 16 may include a device or set of devices that facilitate communication, tactical/situational awareness, environmental and/or personal health monitoring, provide system control and/or status information, and/or other provide functionality for the soldier. In some implementations, first peripheral module 16 may include a wearable chassis into which various modular devices may be selectably and removably installed. Installation into the wearable chassis may enable one of the modular devices to communicate data with wearable combat processing platform 14 and/or or receive power from wearable combat processing platform 14. For instance, the wearable chassis and modular devices may be the same as or similar to the customizable modular helmet system disclosed in U.S. patent application Ser. No. 12/246,272, entitled “Customizable Military Helmet System,” and filed Oct. 6, 2008, which is hereby incorporated by reference into this disclosure in its entirety. In some implementations, first peripheral module 16 may include one or more electromagnetic radiation emitters 28, one or more sensors 30, an electronic display 32, and/or other peripheral devices.

The electromagnetic radiation emitters 28 may be configured to emit electromagnetic radiation. The electromagnetic radiation emitted by electromagnetic radiation emitters 28 may enhance visibility for the soldier, may enable pattern, shape, and/or threat detection by one or more of sensors 30, and/or server other purposes. In some implementations, electromagnetic radiation emitters 28 may include one or more Light Emitting Diodes (“LEDs”). The electromagnetic radiation emitters 28 may receive power from power distribution unit 20 within wearable combat processing platform 14.

The sensors 30 may include one or more peripheral devices that generate output signals conveying information about the soldier and/or the environment in which first peripheral module 16 is being deployed. For example, sensors 30 may include one or more of a geolocation sensor (e.g., a GPS sensor, etc.), a hostile threat sensor (e.g., a sniper sensor, etc.), a health or biometrics sensor, and/or other sensor that generate output signals conveying information related to the environment in which first peripheral module 16 is being employed. Sensors 30 may include one or more imaging sensors configured to generate output signals that convey information related to electromagnetic radiation that becomes incident thereon. For instance, an imaging sensor may include a common visible light imaging sensor (e.g., a CCD sensor chip), a long wave infrared thermal imaging sensor, a low light infrared imaging sensor, and/or other imaging sensors. As yet another example, a given one of sensors 30 may provide other functionality related to situational awareness such as, for example, hyper spectral audio sensing, noise filtering or canceling hearing protection, inertial navigation systems, visual illuminators for friend or foe identification, and/other functionality related to situational awareness. Data may be communicated between sensors 30 and wearable combat processing platform 14 via USB signals transmitted to and/or received from sensors 30 by USB hub 24. The sensors 30 may be powered by power distributed by power distribution unit 20 on wearable combat processing platform 14.

The display 32 may be configured to present visual information to the user of system 10. In some instances, display 32 may include a look through display comprising a screen that wraps around in front of the eyes of the user. The screen may enable the user to selectively view information formed on the screen, information behind the screen (as the user looks through the screen), and/or both information formed on the screen and information behind the screen. Display 32 may provide information to the user generated by one or more other peripherals on first peripheral module 16 and/or second peripheral module 18, information received from processor 22, and/or other information. Display 32 may receive video signals generated by video signal generator 26a that control the information displayed on display 32. According to various implementations, a display control 34 may enable the soldier to interact with and/or control the information displayed on display 32. For example, via display control 34 the soldier may select a source of the information to be displayed, select a display mode, input control commands via a graphical user interface or other user interface presented on display 32, and/or otherwise interact with or control the information displayed on display 32.

The second peripheral module 18 may include a device or set of devices that facilitate communication, tactical/situational awareness, environmental and/or personal health monitoring, provide system control and/or status information, and/or other provide functionality for the soldier. In some implementations, first peripheral module 16 may include a wearable chassis that carries various modular peripheral devices. For example, the wearable chassis may include a guard or band that is wearable on the forearm of the soldier. The modular peripheral devices may include, for instance, a system power monitor 36, an electronic display 38, and/or other peripheral devices.

The system power monitor 36 may be configured to provide the soldier with parameters of the power stored in and provided by energy storage devices 12. These parameters may include a current potential, remaining life (at current or predicted usage levels), remaining power, power currently being drawn, and/or other parameters. The information provided to the soldier via system power monitor 36 may be determined, at least in part, by power distribution unit 20 and transmitted to system power monitor 36. the information provided to the soldier via system power monitor 36 may be determined, at least in part, by system power monitor 36 based on information received from power distribution unit 20.

Electronic display 38 may be configured to provide information to the soldier visually. The information provided to the soldier via electronic display 38 may include similar information discussed above with respect to display 32. The electronic display 38 may receive video signals generated by video signal generator 26b that control the information displayed on display 38.

It will be apparent that the description of the peripheral devices described above with respect to first peripheral module 16 and second peripheral module 18 are not intended to be limiting. The first peripheral module 16, second peripheral module 18, and/or other peripheral modules operatively linked with wearable combat processing platform 14 may include other types of peripheral devices that would provide functionality relevant to control, command, and/or performance of military troops. For example, the peripheral devices may include communication devices (e.g., microphone speaker, signal modulator, antenna, etc.), and/or other devices.

In some implementations, the peripheral modules connected to wearable combat processing platform 14 may include other peripheral modules than the ones illustrated in FIG. 1. For example, wearable combat processing platform 14 may be operatively linked with a handheld module, a laptop module, and/or other peripheral modules including one or more peripheral devices.

The first peripheral module 16 may be operatively linked with wearable combat processing platform 14 via a first releasable connection 40. The second peripheral module 18 may be operatively linked with wearable combat processing platform 14 via a second releasable connection 42. In implementations in which wearable combat processing platform 14 is operatively linked with other peripheral modules and/or devices, these operative links may be formed, at least in part, by releasable connections that are the same as or similar to first releasable connection 40 and/or second releasable connection 42, and or other releasable connections.

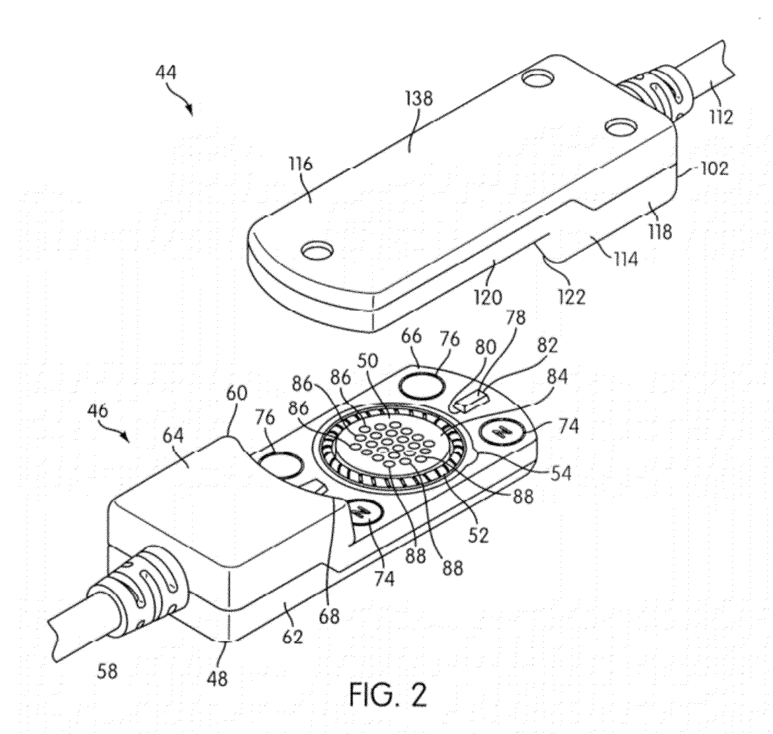

FIG. 2 illustrates first releasable connection 40, in accordance with one or more implementations of the invention. As can be seen, first releasable connection 40 may include a platform connector 44 and a module connector 46. The platform connector 44 and module connector 46 may be releasably coupled by bringing connection interface 50 on module connector 46 in contact with a corresponding connection interface formed on platform connector 44 to enable wearable combat processing platform 14 and first peripheral module 16 to be operatively linked.

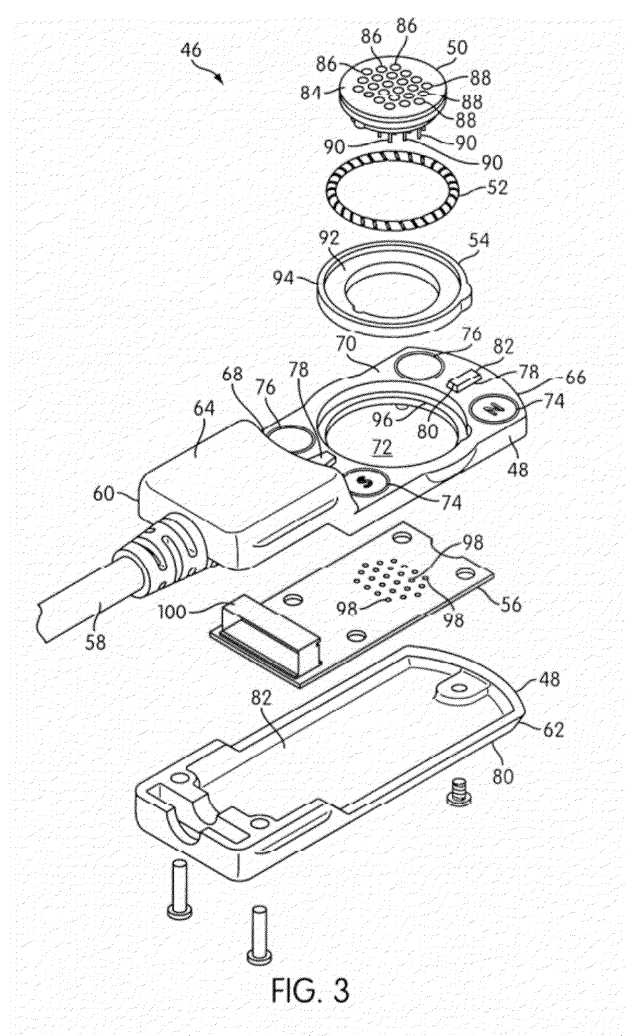

FIG. 3 illustrates an exploded view of module connector 46, according to one or more implementations of the invention. In some implementations, module connector 46 may include a housing 48, a connection interface 50, an o-ring 52, an o-ring receptacle 54, a printed circuit board 56, a cable 58, and/or other components.

The housing 48 may be formed from a first housing section 60 and a second housing section 62. When joined to form housing 48, first housing section 60 and second housing section 62 may protect interior components of module connector 46 and provide a physical interface that can be releasably secured to platform connector 44. One or both of first housing section 60 and/or second housing section 62 may be formed from a rigid polymer, such as Nylon 6 for example, or an elastomeric polymer.

The upper housing section 60 may include a proximate section 64 and a distal section 66 separated by a step 68. The proximate section 64 may be offset from distal section 66 such that the portion of housing 48 formed by proximate section 64 is somewhat thicker than distal section 66. The difference in thickness between the portion of housing 48 formed by proximate section 64 and distal section 66 may be such that if module connector 46 is connected with platform connector 44, platform connector 44 sits flush with the outer surface of proximate section 64.

The interface between proximate section 64 and distal section 66 formed by step 68 may be shaped to coincide with the shape of a tip of platform connector 44. For example, step 68 may have a generally arcuate shape.

The distal section 66 may include an outer surface 70 having an interface opening 72 formed therein. The outer surface 70 may be substantially planar.

At the periphery of interface opening 72, one or more magnets 74 may be carried by distal section 66. The magnets 74 may be disposed at or near outer surface 70. For example, magnets 74 may be seated in distal section 66 substantially flush with distal section 66. The magnets 74 may include, for instance, rare earth magnets such as neodymium magnets, or other magnetized materials.

At the periphery of interface opening 72, one or more pieces of magnetic, unmagnetized materials 76 may be carried by distal section 66. Pieces of material 76 may be disposed at or near outer surface 70. In some implementations, pieces of material 76 may be seated in distal section 66 of first housing section 60 substantially flush with outer surface 70. According to various implementations, magnets 74 and/or pieces of material 76 may be configured to releasable attract first housing section 60 to corresponding magnets and/or pieces of material disposed in second housing section 62.

The distal section 66 may include one or more ramp protrusions 78 that protrude from outer surface 70. The ramp protrusions 78 may include a first end 80 and a second end 82 that is further from step 68 than first end 80. The second end 82 may protrude from outer surface 70 farther than first end 80, giving ramp protrusions 78 the general shape of a ramp. When module connector 46 is engaged with platform connector 44, ramp protrusions 78 may engage a corresponding structure on platform connector 44 (as discussed below). Ramp protrusions 78 may be shaped such that if module connector 46 and platform connector 44 are coupled and begin to move relative to each other in a direction substantially parallel with outer surface 70, ramp protrusions 78 push outer surface 70 away from platform connector 44. This may prevent damage to module connector 46 and/or platform connector 44 in situations where platform connector 44 and module connector 46 are disconnected abruptly.

The second housing section 62 may include a back surface 80. The back surface 80 may be generally planar. The back surface 80 may face substantially the opposite direction of outer surface 70 when second housing section 62 and first housing section 60 are joined to form housing 48. On the inner side of second housing section 62 opposite back surface 80, second housing section 62 may form a board seat 82. The board seat 82 may be configured to provide a seat for printed circuit board 56 when printed circuit board 56 is installed within housing 48.

The connection interface 50 may be configured to provide the electronic interface that enables module connector 46 to be electronically coupled with platform connector 44. The connection interface 50 may include a nonconductive base 84 and a plurality of conductive mating elements 86.

The base 84 may be formed from a nonconductive material (e.g., a material similar to the one used to form housing 48). Base 84 may have a shape that generally matches interface opening 72 formed in first housing section 60 (e.g., round). Base 84 may include a plurality of openings formed therein, through which conductive mating elements 86 pass. The openings may be configured to seat conductive mating elements 86. For module connector 46, base 84 may include openings for 24 conductive mating elements.

The conductive mating elements 86 may be formed from a conductive material. The conductive mating elements 86 of module connector 46 may include a head portion 88, and a tail portions 90. The head portions 88 of conductive mating elements 86 may be exposed to interface with corresponding elements of platform connector 44 (discussed below). The conductive mating elements 86 of module connector 46 may be “female” in that they do not protrude from module connector 46. In fact, In some implementations, head portions 88 of conductive mating elements 86 sit substantially flush with base 84. This may provide an enhancement over connectors in which the female mating elements sit below an interface surface in that the connections of head portions 88 can be easily cleaned (e.g., by brushing off debris). The tail portions 90 of conductive mating elements 86 may extend through the openings formed in base 84 down into module connector 46.

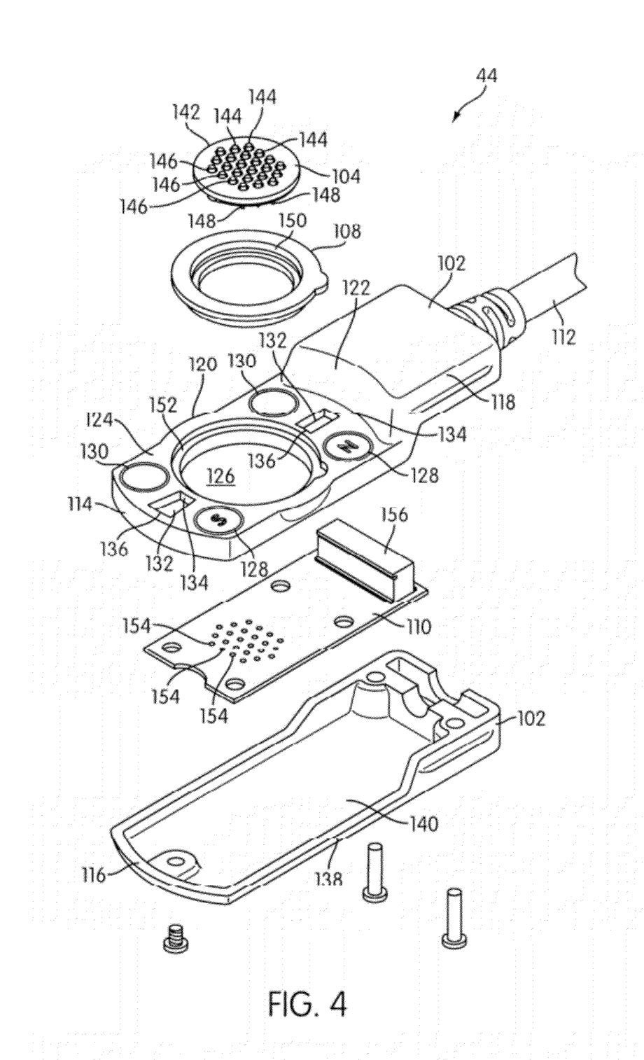

O-ring 52 may be configured to shield the electromagnetic interface provided by conductive mating elements 86 from interference by ambient electromagnetic radiation. In some implementations, o-ring 52 may substantially seal the interior of housing 48 from contamination. O-ring 52 may be formed such that the shape of o-ring 52 corresponds substantially to the shape of base 84. For example, in the implementations illustrated in FIG. 4, base 84 is round, and o-ring 52 has an annular shape. The o-ring 52 may be formed from material(s) that provide shielding from electromagnetic radiation and/or material(s) that provide protection from contamination. For example, o-ring 52 may be formed from a silicone tube encased in copper.

The o-ring receptacle 54 may be configured to engage o-ring 52 and first housing section 60, and to provide a seat for base 84. The o-ring receptacle 54 may include a seat portion 92 and a rim 94. The seat portion 92 may provide a relatively flat, annular surface upon which o-ring 52 and/or base 84 may be seated. The rim 94 may protrude from seat portion 92 to retain o-ring 52 and/or base 84. The o-ring receptacle 54 may be formed from material(s) that provides additional shielding from electromagnetic radiation and/or protection from contamination. For example, o-ring receptacle 54 may be formed from brass. When housing 48 is assembled, a surface of o-ring receptacle 54 opposite the surface that seats o-ring 52 and/or base 84 may be seated in a receptacle seat 96 formed in first housing section 60 at the periphery of interface opening 72.

The printed circuit board 56 may include terminal 98 configured to receive tail portions 90 of conductive mating elements 86. A cable terminal 100 may be disposed on printed circuit board 56 away from terminals 98. The cable terminal 100 may be configured to receive individual conductive lines that run to housing 48 within cable 58. On printed circuit board 56 lines may be printed that connect terminals 98 with cable terminal 100. As such, printed circuit board 56 may provide individual links between conductive mating elements 86 and the conductive lines that run to housing 48 through cable 58.

FIG. 4 illustrates an exploded view of platform connector 44, according to one or more implementations of the invention. In some implementations, platform connector 44 may include a housing 102, a connection interface 104, a base receptacle 108, a printed circuit board 110, a cable 112, and/or other components.

The housing 102 may correspond generally to housing 48 (shown in FIG. 3 and described above). As such, housing 102 may be formed from a first housing section 114 and a second housing section 116. When joined to form housing 102, first housing section 114 and second housing section 116 may protect interior components of platform connector 44 and provide a physical interface that can be releasably secured to module connector 46. One or both of first housing section 114 and/or second housing section 116 may be formed from a rigid polymer, such as Nylon 6 for example, or an elastomeric polymer.

The upper housing section 60 may include a proximate section 118 and a distal section 120 that correspond to proximate section 64 and distal section 66 of module connector 46 (shown in FIG. 3 and described above). Proximate section 118 and distal section 120 may be separated by a step 122.

The distal section 120 may include an outer surface 124 having an interface opening 126 formed therein. The outer surface 124 may be substantially planar.

At the periphery of interface opening 126, one or more magnets 128 may be carried by distal section 120. The magnets 128 may be disposed at or near outer surface 124. For example, magnets 128 may be seated in distal section 120 substantially flush with outer surface 124. The magnets 128 may include, for instance, rare earth magnets such as neodymium magnets, or other magnetized materials. The position of magnets 128 with respect to the plane of outer surface 124 may coincide with the positions of pieces of magnetic, unmagnetized materials 76 disposed in distal section 66 of module connector 46 (shown in FIG. 3 and described above). When module connector 46 is interfaced with platform connector 44, magnetic attraction between magnets 128 and pieces of material 76 may generate a force that holds connectors 44 and 46 in place with respect to each other.

At the periphery of interface opening 126, one or more pieces of magnetic, unmagnetized materials 130 may be carried by distal section 120. Pieces of material 130 may be disposed at or near outer surface 124. Pieces of material 130 may be seated in distal section 120 of first housing section 114 substantially flush with outer surface 124. The position of pieces of material 130 with respect to the plane of outer surface 124 may coincide with the positions of magnets 74 disposed in distal section 66 of module connector 46 (shown in FIG. 3 and described above). When module connector 46 is interfaced with platform connector 44, magnetic attraction between pieces of material 130 and magnets 74 may generate a force cooperates with the magnetic force between magnets 128 and pieces of material 76 to hold connectors 44 and 46 in place with respect to each other.

The distal section 120 may include one or more indentations 132 into outer surface 124. The indentations 132 may include a first end 134 and a second end 136 that is further from step 122 than first end 134. The first end 134 of indentation 132 may intrude into outer surface 124 farther than second end 136, giving the floor of indentation 132 the general shape of a ramp. When platform connector 44 is engaged with module connector 46, indentations 132 may engage ramp protrusions 78 such that ramp protrusions sit within indentations 132. If module connector 46 and platform connector 44 are coupled, with protrusions 78 seated in indentations 132, and begin to move relative to each other in a direction substantially parallel with outer surfaces 70 and 124, protrusions 78 and the floor of indentations 132 cooperate to push connectors 44 and 46 away from each other. This may prevent damage to module connector 46 and/or platform connector 44 in situations where platform connector 44 and module connector 46 are disconnected abruptly.

The second housing section 116 may correspond to second housing section 62. Second housing section 116 may include a back surface 138. On the inner side of second housing section 116 opposite back surface 138, second housing section 116 may form a board seat 140. The board seat 140 may be configured to provide a seat for printed circuit board 110 when printed circuit board 110 is installed within housing 102.

The connection interface 104 may correspond to connection interface 50. Connection interface 104 may be configured to provide the electronic interface that enables platform connector 44 to be electronically coupled with module connector 46 at connection interface 50. The connection interface 104 may include a nonconductive base 142 and a plurality of conductive mating elements 144.

The base 142 may be formed from a nonconductive material (e.g., a material similar to the one used to form housing 102). Base 142 may have a shape that generally matches interface opening 126 formed in first housing section 114 (e.g., round). Base 142 may include a plurality of openings formed therein, through which conductive mating elements 144 pass. The openings may be configured to seat conductive mating elements 144.

The conductive mating elements 144 may be formed from a conductive material. The conductive mating elements 144 of platform connector 44 may include a head portion 146, and a tail portion 148. The head portions 146 of conductive mating elements 144 may be exposed to interface with corresponding elements of module connector 46 (conductive mating elements 86). The conductive mating elements 144 of platform connector 44 may be “male” in that they protrude from connection interface 104. In implementations in which conductive mating elements 144 are male, head portions 146 that protrude from the plane of the top surface of base 142 may be pogo pins that are spring loaded to protrude, but can be pressed back into base 142 (e.g., by virtue of force exerted on head portions 146 by conductive mating elements 86 of module connector 46). This may ensure secure electrical connections are maintained between conductive mating elements 144 and conductive mating elements 86 without requiring insertion of the male mating elements 144 into a cavity.

The base receptacle 108 may include a seat portion 150. The seat portion 150 may provide a relatively flat, annular surface upon which base 142 may be seated. The base receptacle 108 may be formed from material(s) that provide shielding from electromagnetic radiation and/or protection from contamination for components of platform connector 44. For example, base receptacle 108 may be formed from brass. When housing 102 is assembled, an outer surface of base receptacle 108 may be seated in a receptacle seat 152 formed in first housing section 114 at the periphery of interface opening 126.

The printed circuit board 110 may include terminals 154 configured to receive tail portions 148 of conductive mating elements 144. A cable terminal 156 may be disposed on printed circuit board 110 away from terminals 154. The cable terminal 156 may be configured to receive individual conductive lines that run to housing 102 within cable 112. On printed circuit board 110 conductive lines may be printed that connect terminals 154 with cable terminal 156. As such, printed circuit board 110 may provide individual links between conductive mating elements 144 and the conductive lines that run to housing 102 through cable 112.

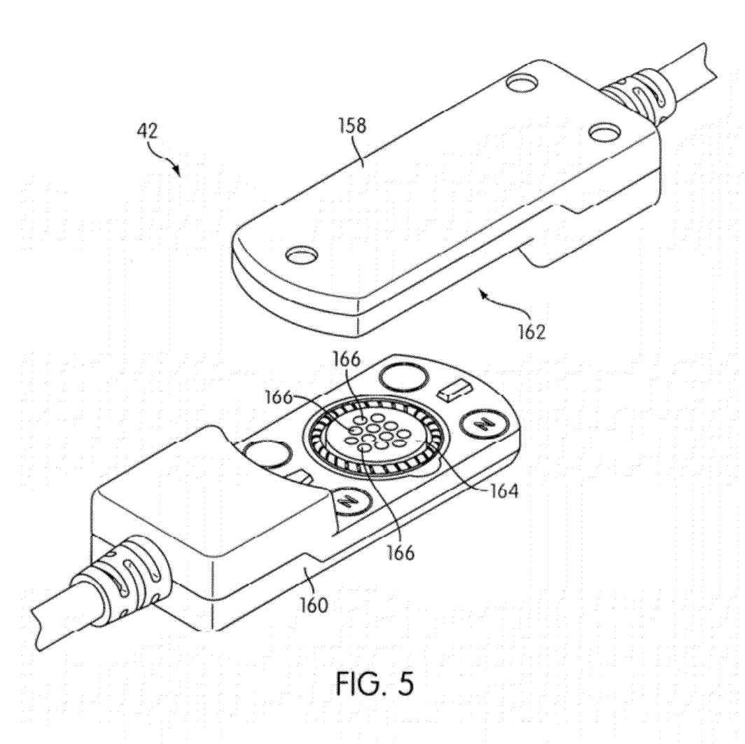

FIG. 5 illustrates a platform connector 158 and a module connector 160 of second releasable connection 42, in accordance with one or more implementations of the invention. As can be see in FIG. 5, platform connector 158 corresponds to platform connector 44 of first releasable connection 40 (shown in FIGS. 3 and 4, and described above). Platform connector 158 may be substantially the same as platform connector 44, with the exception of a connection interface 162 that may include a different number of conductive mating elements than connection interface 104. Similarly, module connector 160 may correspond to module connector 46. Module connector 160 may be substantially the same as module connector 46, with the exception of a connection interface 164 that may include a different number of conductive mating elements 166 than connection interface 50 of modular connector 46. The number of conductive mating elements on connection interface 162 and the number of conductive mating elements 166 on connection interface 164 may be 12.

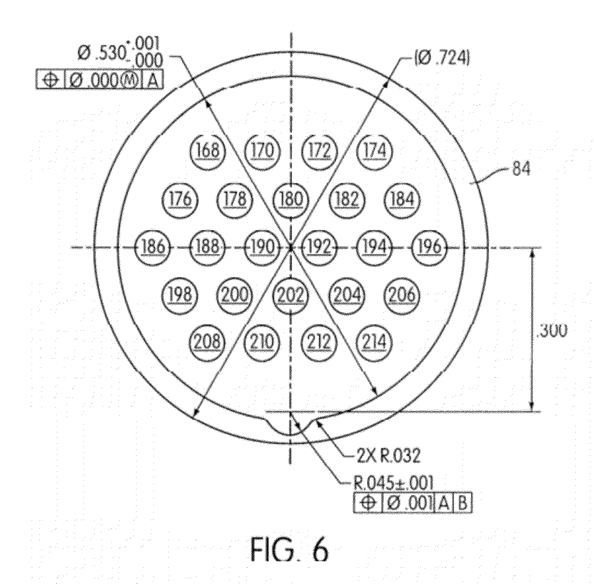

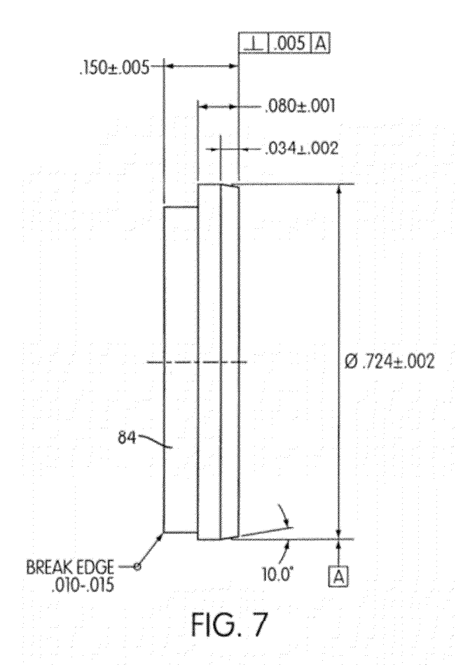

FIGS. 6-8 illustrate base 84 of a connection interface of a module connector (e.g., connection interface 50 of module connector 46), in accordance with one or more implementations. In particular, FIGS. 6, 7, and 8 illustrate a front, side, and rear elevation, respectively, of base 84. FIGS. 6-8 provide dimensions for the overall size of base 84 and the placement of openings in base 84 to accommodate the conductive mating elements that will be mounted into base 84 (e.g., conductive mating elements 86 illustrated in FIG. 4 and described above).

As was mentioned above, the releasable connection of which the module connector carrying base 84 is a part (e.g., first releasable connection 40) may be provided to enable an operative link between a wearable combat processing platform and a peripheral module (e.g., the operative link between wearable combat processing platform 14 and peripheral module 16 shown in FIG. 1 and described above). In order to provide this operative link, base 84 may form 24 openings to accommodate 24 conductive mating elements.

The 24 conductive mating elements to be disposed in the 24 openings formed in base 84 may include 3 sets of conductive mating elements. A first set of conductive mating elements may be configured to transmit and/or receive signals that enable USB communication between a wearable combat processing platform and a peripheral module. The first set of conductive mating elements may include one or more of a conductive mating element that sits in an opening 168 of base 84, a second conductive mating element that sits in an opening 170 of base 84, a third conductive mating element that sits in an opening 172 of base 84, and/or a fourth conductive mating element that sits in an opening 174 of base 84. The first conductive mating element may be configured to receive a HI voltage signal (e.g., +5V). The second conductive mating element may be configured to receive a LO voltage signal (e.g., 0V). The third conductive mating element and the fourth conductive mating elements may be configured to receive data signals transmitted between the wearable combat processing platform and the peripheral module over a twisted pair of cables. These signals may be referred to as D+ and D−.

A second set of conductive mating elements may be configured to provide power from the wearable combat processing platform to the peripheral module. The second set of conductive mating elements may include one or more of a first conductive mating element that sits in an opening 176 and/or a second conductive mating element that sits in an opening 178. The first conductive mating element may be configured to receive a signal that grounds the power circuit of the peripheral module (e.g., 0V). The second conductive mating element may be configured to receive power to the peripheral module at some predetermined potential (e.g., 12V). The power received over the second conductive mating element may be DC.

A third set of conductive mating elements may be configured to enable video information to be transmitted from the wearable combat processing platform to the peripheral module. The video information may be conveyed in the form of VGA signals. The third set of conductive mating elements may include one or more of a first conductive mating element that sits in an opening 180, a second conductive mating element that sits in an opening 182, a third conductive mating element that sits in an opening 184, a fourth conductive mating element that sits in an opening 186, a fifth conductive mating element that sits in an opening 188, a sixth conductive mating element that sits in an opening 190, a seventh conductive mating element that sits in an opening 192, an eighth conductive mating element that sits in an opening 194, a ninth conductive mating element that sits in an opening 196, a tenth conductive mating element that sits in an opening 198, an eleventh conductive mating element that sits in an opening 200, a twelfth conductive mating element that sits in an opening 202, a thirteenth conductive mating element that sits in an opening 204, a fourteenth conductive mating element that sits in an opening 206, a fifteenth conductive mating element that sits in an opening 208, a sixteenth conductive mating element that sits in an opening 210, a seventeenth conductive mating element that sits in an opening 212, and an eighteenth conductive mating element that sits in an opening 214. The first through eighteenth conductive mating elements may be configured to carry video data signals that enable the transmission of video information from the wearable combat processing platform to the peripheral module.

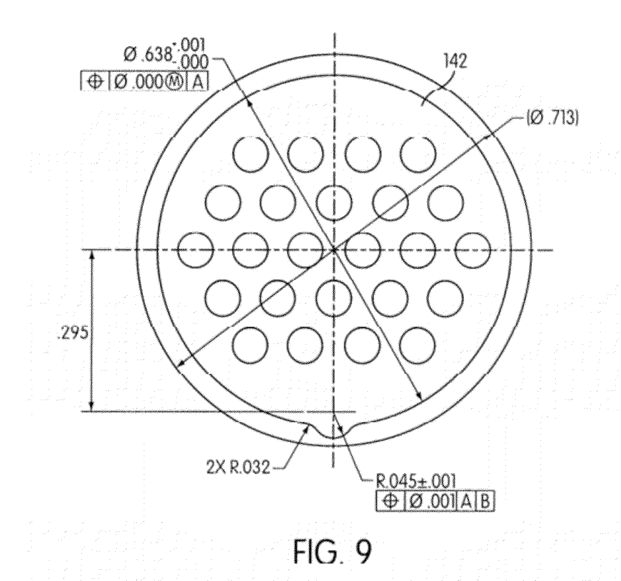

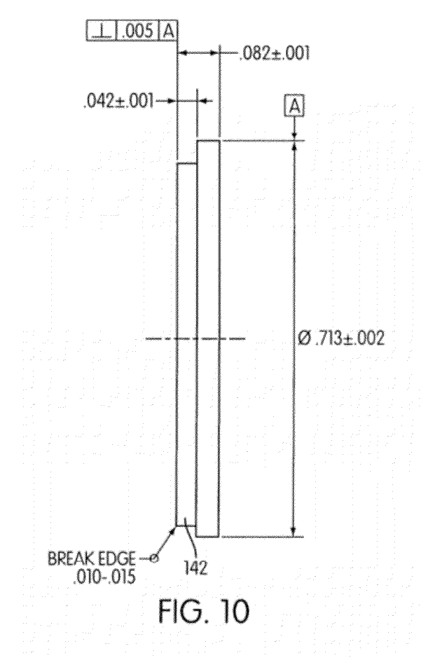

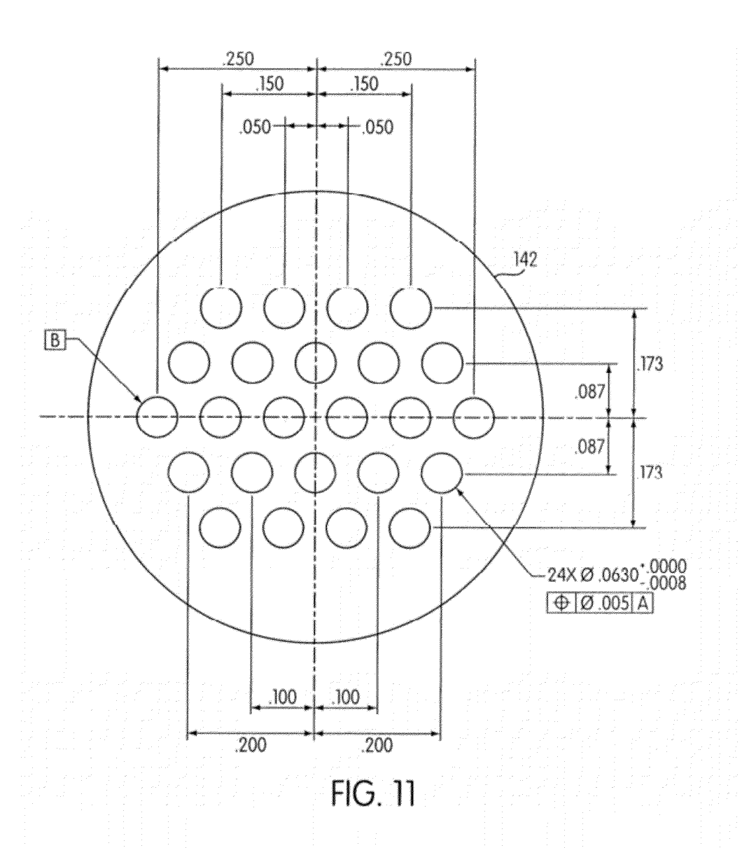

FIGS. 9-11 illustrate base 142 of a connection interface of a platform connector (e.g., connection interface 104 of platform connector 44), in accordance with one or more implementations. In particular, FIGS. 9, 10, and 11 illustrate a front, side, and rear elevation, respectively, of base 142. FIGS. 9-11 provide dimensions for the overall size of base 142 and the placement of openings in base 142 to accommodate the conductive mating elements that will be mounted into base 142 (e.g., conductive mating elements 144 illustrated in FIG. 4 and described above).

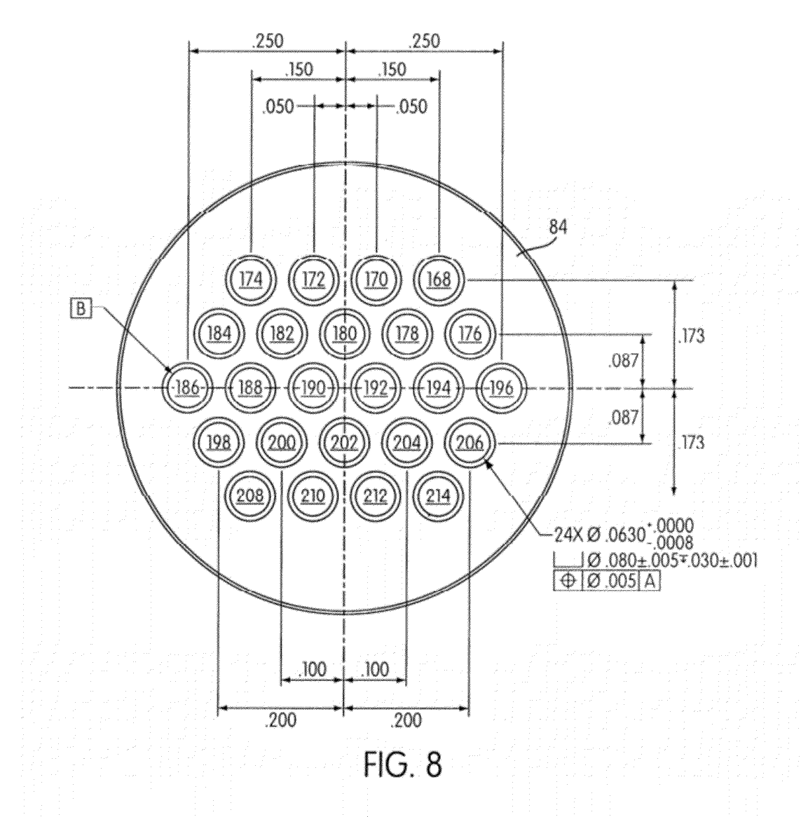

In order to enable the conductive mating elements that get mounted into the openings of base 142 to connect with the conductive mating elements mounted into the openings of base 84 (e.g., as shown in FIGS. 6 and 8). As such, the conductive mating elements mounted into the openings of base 142 may include three sets of conductive mating elements that correspond in placement and function to the three sets of conductive mating elements described above with respect to FIGS. 6-8.

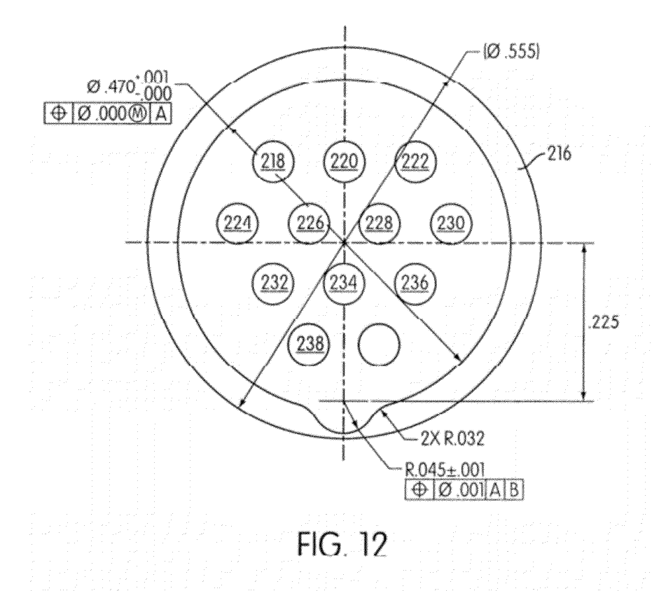

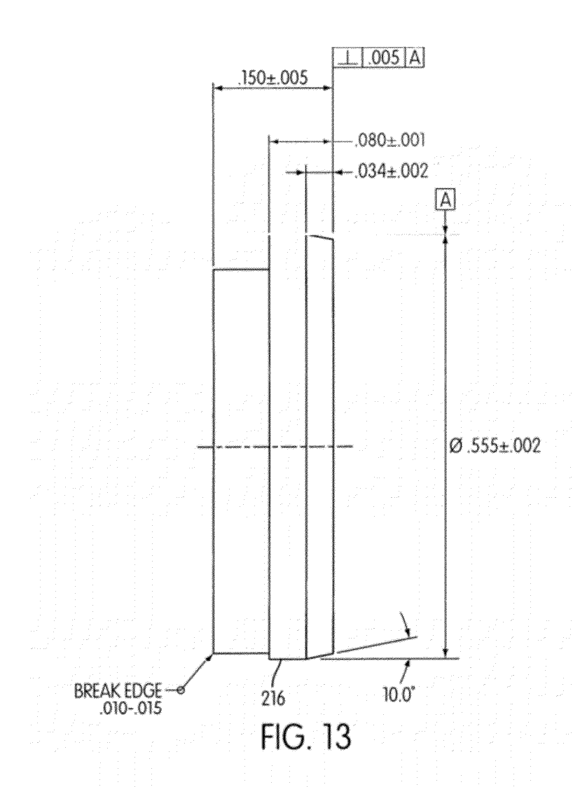

FIGS. 12-14 illustrate a base 216 of a connection interface of a module connector (e.g., connection interface 164 of module connector 160), in accordance with one or more implementations. In particular, FIGS. 12, 13, and 14 illustrate a front, side, and rear elevation, respectively, of base 216. FIGS. 12-14 provide dimensions for the overall size of base 216 and the placement of openings in base 216 to accommodate the conductive mating elements that will be mounted into base 216 (e.g., conductive mating elements 166 illustrated in FIG. 5 and described above).

As was mentioned above, the releasable connection of which the module connector carrying base 164 is a part (e.g., second releasable connection 42) may be provided to enable an operative link between a wearable combat processing platform and a peripheral module (e.g., the operative link between wearable combat processing platform 14 and peripheral module 16 shown in FIG. 1 and described above). In order to provide this operative link, base 164 may form 12 openings to accommodate 12 conductive mating elements.

The 12 conductive mating elements to be disposed in the 12 openings formed in base 216 may include 4 sets of conductive mating elements. A first set of conductive mating elements may be configured to transmit and/or receive signals that enable USB communication between a wearable combat processing platform and a peripheral module. The first set of conductive mating elements may include one or more of a conductive mating element that sits in an opening 218 of base 216, a second conductive mating element that sits in an opening 220 of base 216, a third conductive mating element that sits in an opening 222 of base 216, and/or a fourth conductive mating element that sits in an opening 224 of base 216. The first conductive mating element may be configured to receive a HI voltage signal (e.g., +5V). The second conductive mating element may be configured to receive a LO voltage signal (e.g., 0V). The third conductive mating element and the fourth conductive mating elements may be configured to receive data signals transmitted between the wearable combat processing platform and the peripheral module over a twisted pair of cables. These signals may be referred to as D+ and D−.

A second set of conductive mating elements may be configured to provide power from the wearable combat processing platform to the peripheral module. The second set of conductive mating elements may include one or more of a first conductive mating element that sits in an opening 226 and/or a second conductive mating element that sits in an opening 228. The first conductive mating element may be configured to receive a signal that grounds the power circuit of the peripheral module (e.g., 0V). The second conductive mating element may be configured to receive power to the peripheral module at some predetermined potential (e.g., 12V). The power received over the second conductive mating element may be DC.

A third set of conductive mating elements may be configured to enable video information to be transmitted from the wearable combat processing platform to the peripheral module. The video information may be conveyed in the form of NTSC signals. The third set of conductive mating elements may include one or more of a first conductive mating element that sits in an opening 230 and/or a second conductive mating element that sits in an opening 232.

A fourth set of conductive mating elements may be configured to carry signals related to power distribution by the wearable combat processing platform from one or more attached energy supplies (e.g., energy supply devices 12 illustrated in FIG. 1 and described above). For example, these signals may include signals conveying one or more parameters of the power being distributed. These parameters may include a current potential, remaining life (at current or predicted usage levels), remaining power, power currently being drawn, and/or other parameters. The fourth set of conductive mating elements may include a first conductive mating element that sits in an opening 234, a second conductive mating element that sits in an opening 236, and a third conductive mating element that sits in an opening 238.

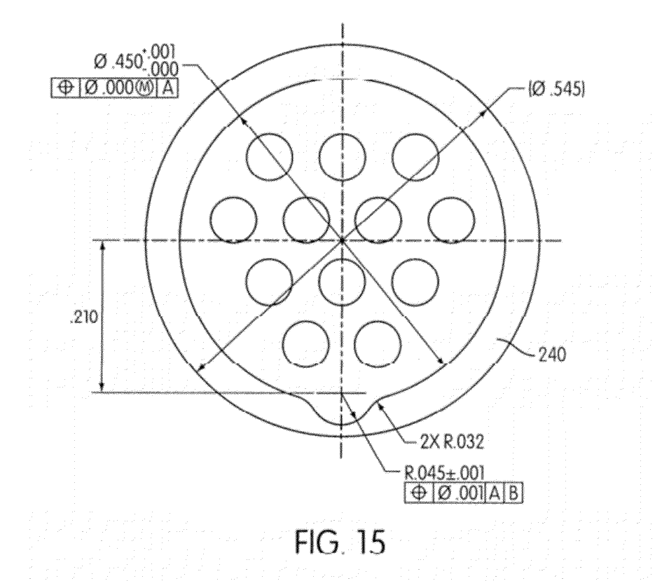

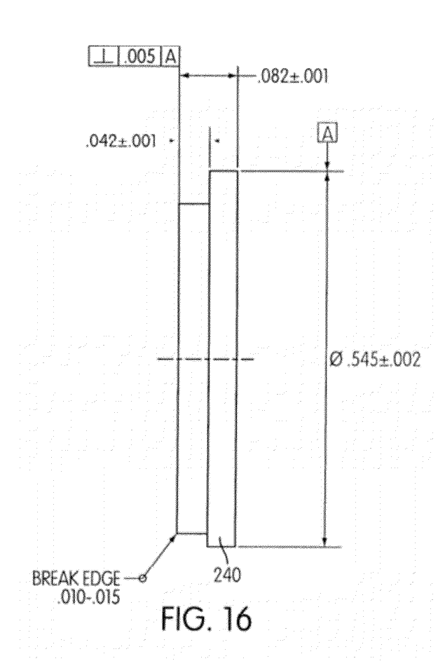

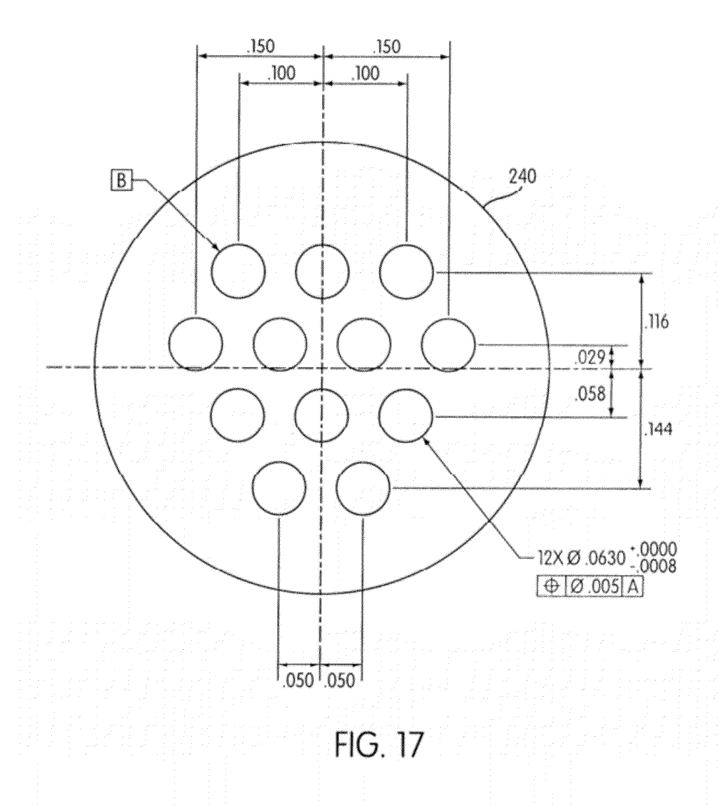

FIGS. 15-17 illustrate a base 240 of a connection interface of a platform connector (e.g., connection interface 162 of platform connector 158), in accordance with one or more implementations. In particular, FIGS. 15, 16, and 17 illustrate a front, side, and rear elevation, respectively, of base 240. FIGS. 15-17 provide dimensions for the overall size of base 240 and the placement of openings in base 240 to accommodate the conductive mating elements that will be mounted into base 240.

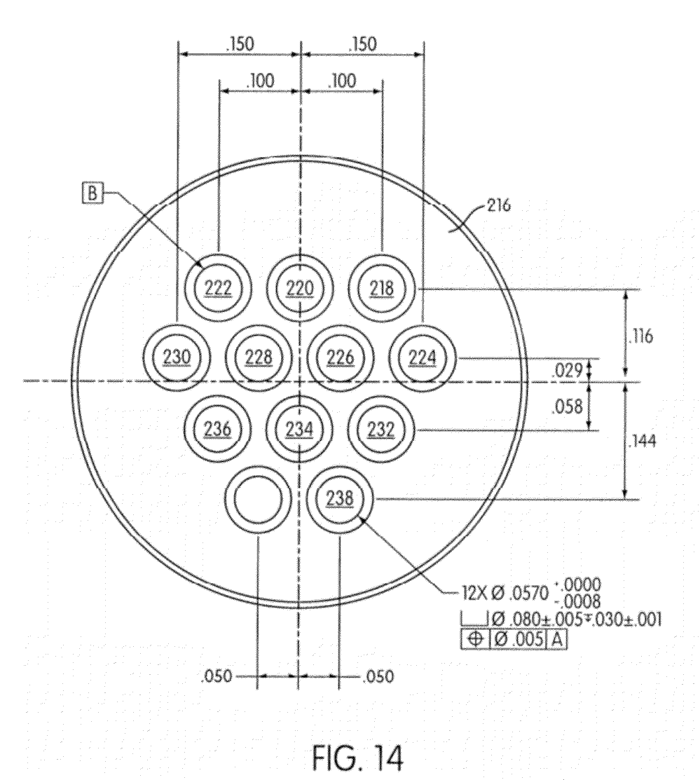

In order to enable the conductive mating elements that get mounted into the openings of base 240 to connect with the conductive mating elements mounted into the openings of base 216 (e.g., as shown in FIGS. 12 and 14). As such, the conductive mating elements mounted into the openings of base 240 may include 4 sets of conductive mating elements that correspond in placement and function to the 4 sets of conductive mating elements described above with respect to FIGS. 12-14.

The description of the releasable connections and/or connectors above, and their corresponding illustration in the figures, as being disposed within a system for use by a soldier in a battlefield context is not intended to be limiting. The releasable connection and/or connectors may be implemented to facilitate the effectiveness of troops in a variety of service contexts. Similarly, the connectors and/or releasable connections may be deployed in systems other than in the system designed for soldiers described above (e.g., civilian contexts).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A peripheral module configured to operatively link with a wearable combat processing platform, wherein the wearable combat processing platform comprises one or more processors and a power distribution unit, the peripheral module comprising:
a connector configured to form at least a portion of the operative link between the wearable combat processing platform and the peripheral module; and
one or more peripherals configured to communicate data and to receive power over the operative link with the wearable combat processing platform,
wherein the connector comprises:
a housing carrying a connection interface on a first side, wherein the connection interface comprises at least 10 conductive mating elements including:
a first set of one or more conductive mating elements configured to enable Universal Serial Bus communication between the wearable combat processing platform and the peripheral module;
a second set of one or more conductive mating elements configured to enable the provision of DC power to the peripheral module through the connector; and
a third set of one or more conductive mating elements configured to enable video information to be transmitted from the wearable combat processing platform to the peripheral module.

2. The peripheral module of claim 1, further comprising:
one or more magnets disposed at or near the first side of the housing at the periphery of the at least 10 conductive mating elements; and
one or more pieces of magnetic, unmagnetized material disposed at or near the first side of the housing at the periphery of the at least 10 conductive mating elements.

3. The peripheral module of claim 1, further comprising a cable extending from the housing in a first direction, the cable being configured to carry signals received by the at least 10 conductive mating elements toward the peripheral module, wherein the first side of the housing faces a direction that is substantially perpendicular to the first direction.

4. The peripheral module of claim 1, wherein the connection interface includes a substantially planar surface on the first side of the housing, and wherein the at least 10 conductive mating elements are substantially flush with the substantially planar surface.

5. The peripheral module of claim 1, wherein the at least 10 conductive mating elements comprise 12 conductive mating elements.

6. The peripheral module of claim 1, wherein the at least 10 conductive mating elements comprise 24 conductive mating elements.

7. The peripheral module of claim 1, wherein the first set of conductive mating elements comprises:
a first conductive mating element configured to receive a 5 Volt signal from the wearable combat processing platform;
a second conductive mating element configured to communicate data signals between the wearable combat processing platform and the peripheral module;
a third conductive mating element separate from the second conductive mating element, the third conductive mating element being configured to communicate data signals between the wearable combat processing platform and the peripheral module; and
a fourth conductive mating element configured to receive be grounded with a Universal Serial Bus interface in the wearable combat processing platform.

8. The peripheral module of claim 7, wherein the second set of conductive mating elements comprises:
a first conductive mating element configured to receive a DC potential from the wearable combat processing platform; and
a second conductive mating element configured to receive be grounded with the power distribution unit in the wearable combat processing platform, wherein the second conductive mating element of the second set of conductive mating elements is separate from the fourth conductive mating element of the first set of conductive mating elements.

9. The peripheral module of claim 1, further comprising one or more ramp protrusions that extend from the first side of the housing, wherein a given one of the ramp protrusions protrudes by a gradually increasing amount from a lower side of the ramp protrusion to a higher side of the ramp protrusion.

10. The peripheral module of claim 9, wherein the one or more ramp protrusions are formed such that if the connector is interfaced with a platform connector associated with the wearable combat processing platform and a force is applied to the housing of the connector that moves the connector relative to the platform connector in a direction generally parallel with the first side of the housing, the one or more ramp protrusions force the connector and the platform connector apart.

11. A connector configured to form at least a portion of an operative link between a wearable combat processing platform and a peripheral module, wherein the wearable combat processing platform comprises one or more processors and a power distribution unit, and wherein the peripheral module comprises one or more peripherals configured to communicate data and to receive power over the operative link with the wearable combat processing platform, the connector comprising:
a housing carrying a connection interface on a first side, wherein the connection interface comprises at least 10 conductive mating elements including:
a first set of one or more conductive mating elements configured to enable Universal Serial Bus communication between the wearable combat processing platform and the peripheral module;
a second set of one or more conductive mating elements configured to enable the provision of DC power to the peripheral module through the connector; and
a third set of one or more conductive mating elements configured to enable video information to be transmitted from the wearable combat processing platform to the peripheral module.

12. The connector of claim 11, further comprising:
one or more magnets disposed at or near the first side of the housing at the periphery of the at least 10 conductive mating elements; and
one or more pieces of magnetic, unmagnetized material disposed at or near the first side of the housing at the periphery of the at least 10 conductive mating elements.

13. The connector of claim 11, further comprising a cable extending from the housing in a first direction, the cable being configured to carry signals received by the at least 10 conductive mating elements toward the peripheral module, wherein the first side of the housing faces a direction that is substantially perpendicular to the first direction.

14. The connector of claim 11, wherein the connection interface includes a substantially planar surface on the first side of the housing, and wherein the at least 10 conductive mating elements are substantially flush with the substantially planar surface.

15. The connector of claim 11, wherein the at least 10 conductive mating elements comprise 12 conductive mating elements.

16. The connector of claim 11, wherein the at least 10 conductive mating elements comprise 24 conductive mating elements.

17. The connector of claim 11, wherein the first set of conductive mating elements comprises:
a first conductive mating element configured to receive a 5 Volt signal from the wearable combat processing platform;
a second conductive mating element configured to communicate data signals between the wearable combat processing platform and the peripheral module;
a third conductive mating element separate from the second conductive mating element, the third conductive mating element being configured to communicate data signals between the wearable combat processing platform and the peripheral module; and
a fourth conductive mating element configured to receive be grounded with a Universal Serial Bus interface in the wearable combat processing platform.

18. The connector of claim 17, wherein the second set of conductive mating elements comprises:
a first conductive mating element configured to receive a DC potential from the wearable combat processing platform; and
a second conductive mating element configured to receive be grounded with the power distribution unit in the wearable combat processing platform, wherein the second conductive mating element of the second set of conductive mating elements is separate from the fourth conductive mating element of the first set of conductive mating elements.

19. The connector of claim 11, further comprising one or more ramp protrusions that extend from the first side of the housing, wherein a given one of the ramp protrusions protrudes by a gradually increasing amount from a lower side of the ramp protrusion to a higher side of the ramp protrusion.

20. The connector of claim 19, wherein the one or more ramp protrusions are formed such that if the connector is interfaced with a platform connector associated with the wearable combat processing platform and a force is applied to the housing of the connector that moves the connector relative to the platform connector in a direction generally parallel with the first side of the housing, the one or more ramp protrusions force the connector and the platform connector apart.
